(19) United States
(12) Patent Application Publication
(10) Pub. No.: US 2024/0395423 A1
(43) Pub. Date: Nov. 28, 2024

(54) Pointing and Tracking System for a Laser to a Fusion Target

(71) Applicants: Robert O. Hunter, JR., Aspen, CO (US); Richard B. Holmes, Shingle Springs, CA (US)

(72) Inventors: Robert O. Hunter, JR., Aspen, CO (US); Richard B. Holmes, Shingle Springs, CA (US)

(73) Assignee: Innoven Energy LLC, Solana Beach, CA (US)

(21) Appl. No.: 18/674,098

(22) Filed: May 24, 2024

Related U.S. Application Data
(60) Provisional application No. 63/469,008, filed on May 25, 2023.

(51) Int. Cl. G21B 1/23; G21B 1/03; G21B 1/15

(52) U.S. Cl. CPC G21B 1/23; G21B 1/15; G21B 1/03

(57) ABSTRACT

Various essential elements are required to accurately point one or more lasers toward an aimpoint within an Inertial Confinement Fusion (ICF) system while tracking a non-stationary ICF target. An ICF target may be dropped or propelled into an ICF target chamber. With the help of a plurality of steering mirrors, one or more lasers must accurately reach the desired aimpoint within the ICF target chamber and through the laser entrance holes in the surrounding hohlraum, so that the laser energy is accurately and uniformly applied to cause a target implosion. As the non-stationary ICF target accelerates and rotates within the ICF target chamber, one or more high-resolution, high-speed images are captured. The accurate and precise control of the various elements within the system is performed by a fast processor.

### CROSS REFERENCE TO RELATED APPLICATION

This application claims the benefit of U.S. Provisional Application No. 63/469,008 filed on May 25, 2023, which is incorporated herein by reference.

### BACKGROUND

In an operational Inertial Confinement Fusion (ICF) facility that produces energy via laser fusion, targets must be sequentially ignited in relatively quick succession. Furthermore, the debris from any target and any supporting structure should be minimized. These considerations favor an approach in which a target falls into the detonation chamber rather than being carried in by a supporting structure. To enable such an approach, the falling target must be hit accurately by the laser. Another objective is to minimize corruption of targets prior to their detonation, in part due to warming during flight. Such timely, accurate pointing of the laser may involve one or more steering mirrors which rapidly point/steer the one or more high-energy lasers. To set the angular position of the steering mirrors, a tracking sensor is used to identify the position and orientation of the target as it falls, but well before the target is ignited so that the sensor can be shielded from detonation. Predictive pointing may be performed to hit the target based on its prior observed position, velocity, and acceleration and its corresponding angular motion. Also, because the laser is so intense, it is desirable to point the laser before it is amplified to its full pulse energy, so that optics are not damaged or destroyed by the intense laser light.

There are three publicly available prior-art approaches to the problem of insertion of targets at rates of greater than once an hour at this time. J. Laughon & K. R. Schultz, “Inertial Confinement Fusion Target Insertion Concepts for the National Ignition Facility,” Fusion Technology, Vol. 30, Issue 3P2A, pp. 471-474 (1996) focuses on a retractable arm or mechanism to insert a target and does not involve steering of the laser. W. Lin, J. Zhu, Z. Liu, X. Pang, Y. Zhou, W. Cui, Z. Dong, “Target alignment method of inertial confinement fusion facility based on position estimation,” Nuclear Engineering and Technology, Vol. 54, Issue 10, pp. 3703-3716 (2022) describes the location and repositioning (alignment) of quasi-stationary targets. This approach also does not involve steering of the laser. R. L. Fagaly, L. C. Brown, R. B. Stephens and M. D. Wittman, “Inertial confinement fusion target insertion via augmented mass free fall,” Proceedings of 16th International Symposium on Fusion Engineering, vol. 1, pp. 26-28 (1995) describes a free-falling target, but the emphasis is on reducing uncertainty in the falling target position by used of mass augmentation to reduce the variable effects of drag on the target. It also does not involve steering the laser. Thus, none of these approaches uses a steering mirror to guide a laser, and particularly a seed laser, to a potentially non-stationary target. NIF uses a target pedestal for quasi-stationary targets for shots that are conducted at intervals of roughly 1 month between full-energy shots.

### SUMMARY

There are various essential elements to accurately point and track within the ICF system. One or more steering mirrors, which should be in a location at which the laser has sufficiently low fluence such that the mirror will not be damaged, are needed to guide the laser light. Such mirror(s) are located a significant distance from the target and off to the side in a seed laser path in the preferred embodiment, so that such mirrors are not damaged. An LED-bulb lamp to illuminate the target with narrowband illumination may also be helpful. A tracking sensor is also needed that can see the non-stationary target early enough so that it can accurately command the steering mirror accounting for the mirror's steering time. Also helpful is a seed laser that will ultimately be pointed and amplified to hit the target accurately and with high pulse energy. Also helpful is a laser gain medium between the steering mirror and the target.

A target drop or launch mechanism that holds a queue of targets and drops or launches targets with precise timing and relatively precise positional orientation. A suction mechanism may be used to hold the targets and then release them with near-zero torque. Precise timing of shutters, tracking sensor, target drop, and laser. An additional optional sensor located near the steering mirror that predicts the trajectory accurately.

Various safety measures, such as shutters and insulation, can be used in order to prevent system failures. A shutter in front of the tracking sensor tis essential to protect the sensor from detonation, hence closing before the detonation occurs, with adequate margin. Insulation surrounding the sensor will protect it from local blackbody radiation and the hot detonation chamber as well as hot neutrons. Safety interlocks on shutters to inhibit laser fire in case of shutter failure.

### BRIEF DESCRIPTION OF THE DRAWINGS

FIG. 1 shows a schematic diagram of the pointing and tracking system for a laser to an ICF target.

### SPECIFICATION

The terms “approximately”, “about”, “near”, “roughly” refer to a given value ranging plus/minus 20%. For example, the phrase of “approximately 1 atmosphere” is intended to encompass a range of 0.80 to 1.20 atmosphere.

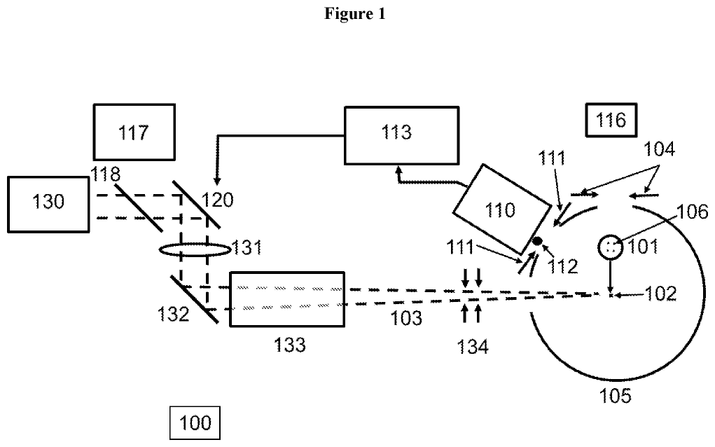

Referring to FIG. 1, the pointing and tracking system 100 includes a drop/launch mechanism 116 to direct a target 101 which should nominally arrive at the desired location within the detonation chamber or aimpoint 102 at the same time as the beam sent from amplified seed laser 103. In the preferred embodiment, mechanism 116 drops/launches target 101 through open shutters 104 into the detonation chamber 105. As the target approaches the aimpoint 102, a wide-field-of-view (WFOV) sensor 110 looks through open shutters 111 at the location of the target to identify the target's position and orientation. Since the detonation chamber is nominally dark as the target falls in, light may be provided by an LED light source 112 so that the WFOV sensor 110 has adequate signal-to-noise ratio (SNR). At least one frame of target imagery is collected during a period of about 1 msec or less. This imagery data is then processed by a fast processor 113 to produce an estimated target location and orientation at the time of arrival of the amplified seed laser pulse 103. This information is converted into angular offsets at the location of a fast-steering mirror (FSM) or mirrors 120. A low-power seed laser beam 130 such as a KrF laser with a pulse energy of 100 to 10,000 Joules per pulse is then created at the appropriate optical frequency and reflects off the FSM or FSMs 120 and is then focused by focusing lens or lenses 131 which focuses the light onto the target. For example, the low-power seed laser beam 130 should have a fluence of less than about 4 Joules per square cm when the laser wavelength is about 248 nm so that it will not damage the optics. The seed laser light then reflects off a blast mirror 132 which functions to protect the low-power optics from the fusion blast emanating from the target explosion. The blast mirror 132 also serves as a turning optic to direct the low-energy seed light toward the target. The seed laser light then passes through a gain region 133 which amplifies the seed laser pulse to the energy and intensity needed to effect fusion. In the preferred embodiment, the gain region comprises either N2 or one of several noble gases and the gain is a result of a nonlinear optical interaction known as stimulated Brillouin scattering (SBS). The amplified seed laser 103, such as a KrF laser with a pulse energy of approximately 1 to 10 MJ per pulse, then proceeds toward the target, passing through the open laser shutter or shutters 134. The drop/launch mechanism 116 ensures that the target 101 and seed laser arrive at the target plane within detonation chamber 105 nearly concurrently. One or more laser entrance holes (LEHs) 106 in the target casing are irradiated by the laser and effect fusion. Timing the drop/launch mechanism 116 and the activation of seed laser 130 to be within about 1.5 microseconds, and such that the laser energy arrives at the LEHs 106 with a spatial accuracy of 15 microns on the target 101, assuming that the target is moving at a velocity of 10 meters per second when it arrives at the pre-planned target aimpoint location 102. Because this may be challenging, this is addressed by the WFOV sensor 110 that observes the detonation chamber 105 for the target as it nears the aimpoint 102. The WFOV sensor provides control of the FSM or FSMs 120 to hit the target with the above accuracy. For example, if the WFOV sensor 110 identifies that target is 3 millimeters behind it's expected location, and the FSM or FSMs 120 are 30 meters away, for example, the FSM will point the laser back by about 3 mm/30 m=0.1 milliradian in about 1 millisecond. The precise control of the FSM or FSMs 120, interpretation of the data from the WFOV sensor 110, and calculations required to compute the FSM offset is performed via the fast processor 113. This control considerably eases the timing accuracy requirement for the drop mechanism to about 3 mm/(10 m/sec)=0.3 milliseconds for a target velocity of 10 m/sec, instead of 1.5 microseconds that is required for 15-micron accuracy.

In addition to the nominal specifications shown above, it is highly desirable to close shutters 104 of the target injection region so that target blast does not heat the targets in the target cue, which are kept at a nominal temperature of approximately 20 K. Further, sensor shutter 111 of the WFOV sensor 110 closes so that the sensor is not blinded and possibly incinerated by the target blast. Also, the laser shutters 134 are highly desirable to separate the target region which is nominally at vacuum conditions of about 10⁻³ of atmospheric pressure or less from the gain region which is nominally at a pressure of 1 atmosphere.

Furthermore, such shutters 134 must open and close fairly quickly. For example, when the laser shutter opens, a rarefaction wave travels from the shutter location back to the gain region. In order to leave the gain region relatively undisturbed, the shutter should be closed before such a wave reaches the gain region. In the nominal case, this distance is about 15 meters, and the speed of a rarefaction wave in helium is about 1000 m/sec, so the time available from opening to closing of the laser shutter 134 is about 15 msec. The WFOV sensor 110 should view the target within about 10 cm of the aimpoint 102, which corresponds to about 10 msec of time available to close the shutter for the WFOV sensor. If the target is dropped from 5 meters above the aimpoint, and the debris shield has a radius of 2 meters, then the time from the target's entrance into the detonation chamber 105 to the time it arrives at the aimpoint 102 is about 113 msec, and this sets the time to close the target-drop shutter 104 in this example.

If such shutters do not open or close properly, then there may be damage to the shutters and the subsystems they protect, rendering them non-functional. Hence it is highly desirable to use safety interlocks, not shown, to stop the laser or the laser seed from firing when shutters have not properly opened or closed.

It may also be observed that target rotation is highly undesirable during the duration from target insertion to target at aimpoint. To mitigate this issue, attention to the target drop/launch mechanism is important in order to reduce such rotation. For example, the target drop/launch mechanism 116 may also consist of a suction device which holds the target from the top region of the target until it is to be dropped, and then releases the target without appreciable torque.

The WFOV sensor 110 can be supplemented or replaced by a narrow-field-of-view (NFOV) sensor, 117, that views the target through a dichroic beam splitter 118 that is near the steering mirror or mirrors 120. Such a NFOV sensor or sensors have limited resolution compared to the WFOV sensor, however. For example, a NFOV sensor with a collection aperture of 25 cm located at 30 meters range from the target and a wavelength of 500 nm will have a diffraction limited resolution of (wavelength)×(range)/aperture=60 microns, which is significantly larger than the desired 20-micron accuracy. A WFOV sensor with a collection aperture of 5 cm located at 2 meters range from the target with the same wavelength will have a diffraction limited resolution of 20 microns. However, when the laser shutters 134 have a relatively small diameter, the FOV of the sensor is limited by the width of the shutters and the length from the shutters to the lens or lenses 131. For either a WFOV sensor 110 or a more distant NFOV sensor 117, positional and rotational accuracy can also be improved by putting small bright reflectors on the target surface (not shown). In an embodiment which has multiple steering mirrors 120, that tile the laser beam aperture, the multiple mirrors can be used to account for target rotations to better hit the laser entrance holes 106.

Table 1 summarizes a preferred embodiment identifying parameters for the pointing and tracking system assuming a dropping target. A dropping target is a preferred embodiment because it minimizes the potential rotations of the target and minimizes potential deformations of the target that would otherwise occur when the target is launched rather than dropped.

TABLE 1
Representative (Example) Key Parameters:

| Parameter | Value |
|---|---|
| Sensor integration time, tₛₑₙₛ | 0.1 msec (TBD) |
| Processing time, t_{proc} | 1 msec |
| FSM response time, t_{fsm} | 5 msec |
| Lead time to sense target and adjust FSM, t_{lead} | tₛₑₙₛ + t_{proc} + t_{fsm} = 6.1 msec |
| Total target drop distance z | 5 meters |
| Total drop time t_{drop} = (2z/g)^{1/21} | 1.0102 sec |
| Corresponding lead-time distance Δz~5.97 | z − g(t_{drop}-6.1 msec)²/2 = 5.97 cm |
| cm, from | |
| Sensor distance from target (detonation | 2 to 5 meters (=radius of impulse |
| chamber | shell) |
| Corresponding angle = radian angular offset | 0.0597/2 = 0.03 radians |
| required for camera | |
| Sensor and sensor light source shuttering | as FSM is pointed |
| FSM pointing required angular range | ±(3 cm)/(30 m) = +1 mrad |
| FSM pointing accuracy | ±(15 um)/30 m = ±0.5 urad (1 urad |
| | may be sufficient) |
| Sensor total field-of-view: | 10 mrad (~2 cm at 2 m range, must |
| | be somewhat more than target size |
| | and comparable to lead ahead) |
| Sensor pixel field-of-view | 5 urad (comparable to required laser |
| | pointing accuracy) |
| Sensor pixel format: | 10 mrad/5 urad = 2K × 2K |
| Sensor readout time | <1 msec (TBD) (maybe sub-frame |
| | ROI readout) |
| Required accuracy of knowledge for start of | <0.5 usec to obtain <5 um error |
| camera readout time | |
| Camera may need to be slewed during | |
| camera integration to reduce image smear | |
| Knowledge of start time accuracy of main | <0.5 usec to support <5 um positional |
| laser based on target tracking | accuracy on target (even more |
| | accurate timing is required for the fast |
| | compressor) |
| Target drop timing accuracy gives ~0.3 cm of | <0.3 msec |
| range for tracking sensor to acquire. | |
| Sensor and light source shutter closure start | Initiate closure immediately after 1 or |
| | 2 quick looks of less than about 1 |
| | msec each by the WFOV sensor 110. |
| Sensor and light source shutter closure | <5 msec to ensure closure before blast |
| duration | |
| Sensor shutter composition | 1.5 cm Beryllium shutter for neutrons + |
| | steel plate for x-rays |
| Target drop shutter start: | Initiate closure 1 msec after target has |
| | cleared |
| Target drop shutter closure duration | <10 msec to ensure closure before |
| | blast |
| Target drop shutter composition and size | Beryllium, 3.0 cm diam |
| Laser path shutter start | 8 msec before laser arrives, fully |
| | opened 1.0 msec before laser arrives |
| Laser path shutter closure duration | Start ~1 msec after detonation, fully |
| | close in <12 msec |
| Laser path shutter composition and size | VAT, Inc. Fast Closing Shutter, |
| | Series 77.1/77.3 VAT spec sheet, 16 |
| | cm diameter |
| Interlocks on shutters will stop laser emission | |
| if any fail to operate correctly. | |

Note that a key requirement shown in Table 1 is the timing of the laser's arrival. With this approach, the required spatial accuracy is about σx=15 um at the target and the required laser timing accuracy is σx/vtgt=1.5 μsec or less. This is stringent, but not as stringent for the timing of the seed laser arrival relative to the main laser (pump laser) arrival, which is approximately 0.1 nanosecond. Note that these timing accuracies must be maintained over the ˜4 microsecond interval required from time of the creation of the main laser's input laser beams to the time for the light arrives at the target.

As discussed above, the sensor shutter 111 for the WFOV sensor 110 must close in about 5 msec after taking one or two snapshots of the target 101 in order to protect the sensor from detonation, hence closing before the detonation occurs, with adequate margin. The shutter should be at least about 5 cm in total width to provide a field-of-view of at least 2 cm, resolution of 20 um or less, and a signal-to-noise ratio of at least 10 for the WFOV sensor 110. The sensor shutter 111 should be at least about 2 cm thick and consist of both beryllium and steel in order to protect the camera from exposure to neutrons and x-rays.

There should be insulation, not shown, surrounding the WFOV sensor 110 in order to protect the sensor from heat from the hot detonation chamber and to protect it from local blackbody radiation and the hot detonation chamber walls. This insulation should be at least 5 cm thick and consisting of non-volatile, non-outgassing material that can withstand temperatures up to 500 C. A cooling system, not shown, may also be needed. The insulation should be enclosed in a steel box that is firmly bolted to the detonation chamber in such a way that the WFOV sensor 110 has drifts of less than 10 microns relative to the detonation chamber 105.

In order to provide adequate signal to the WFOV sensor 110 during the quick looks at the target (1 msec or less) an LED-based lamp 112 will likely be needed to illuminate the target with narrowband illumination. For example, a green or blue LED having a power of 10 Watts will provide an adequate signal-to-noise ratio of approximately 10 or more per pixel of the WFOV sensor 110.

The target drop/launch mechanism 116 holds a queue of targets and drops or launches targets 101 with precise timing, about 0.3 millisecond accuracy as discussed above, and relatively precise positional orientation, about 1 mm. The rotational orientation is also corrected by control of the FSM or FSMs based on a view of the target by the WFOV sensor 110 as described above. In one embodiment involving dropping the target, drop or launch mechanism 116 may include a suction mechanism to hold the targets and then release them with near-zero torque. The suction mechanism would comprise a rubberized orifice with a diameter of about 3 mm and would hold a vacuum of about 10⁻² atmospheres where it contacts the targets. The suction mechanism would be at the top of the target. The target would also be supported from below by a rubberized orifice (not shown) in this example embodiment. When the target 101 is to be dropped, the target is directly above shutter 104 for the target drop or launch mechanism 116. This shutter then flips away, as well as the target support orifice. Because of the low pressure in the overall converter structure 100, the target will fall away from the suction mechanism located at the top of the target. The queue of targets will consist of up to approximately 10 targets in one embodiment, to ensure that a target is always available at the needed time.

In all of the above, the opening and closing start times are controlled to an accuracy of about 0.5 msec, with opening and closing durations that range from 5 to 15 msec. The precise timing of tracking sensor, the target drop, and the laser have already been discussed.

Furthermore, safety interlocks on shutters (not shown) are used to inhibit laser fire in case of shutter failure. This is important because a shutter failure with the shutter closed will render the system inoperable and the laser shutters 134 could be destroyed. This is also important for a shutter failure with the shutter open, which will destroy the WFOV sensor 110, or the target drop or launch mechanism 116.

The specifications displayed and described herein are examples only, and not intended to limit the general principles of the invention.

1. A system for pointing and tracking a non-stationary target reaching an aimpoint within an Inertial Confinement Fusion (ICF) system, the system comprising:
a non-stationary ICF target;
a detonation chamber that receives the non-stationary ICF target;
a seed laser that emits a laser light having a low-pulse energy toward the detonation chamber;
one or more steering mirrors, wherein the one or more steering mirrors manipulate the laser light from the seed laser toward the non-stationary ICF target;
a laser gain medium that amplifies the laser light emitted by the seed laser from a low pulse energy to a high pulse energy, and wherein the laser gain medium is positioned between the one or more steering mirrors and the detonation chamber;
a target launch mechanism, wherein the target launch mechanism launches the non-stationary ICF target into the detonation chamber to reach an aimpoint;
one or more tracking sensors, wherein the one or more tracking sensors observe a position and angular orientation of the non-stationary ICF target as the non-stationary ICF target moves closer to and reaches the aimpoint; and
a processing system, wherein the processing system controls the one or more steering mirrors, the target launch mechanism, and the one or more tracking sensors.

2. The system of claim 1, further comprising:
a LED light source that illuminates the detonation chamber as the non-stationary ICF target is launched into the detonation chamber from the target launch mechanism.

3. The system of claim 2, further comprising:
a laser shutter located between the one or more steering mirrors and the target chamber.

4. The system of claim 3, wherein the target launch mechanism further comprises:
launching the non-stationary ICF target through the target shutter before entering the detonation chamber at a precise time and positional orientation.

5. The system of claim 4, wherein the processing system further comprises:
controlling the target shutter.

6. The system of claim 5, wherein the one or more tracking sensors further comprises:
sensing the position and orientation information from the non-stationary ICF target located within the target chamber through a sensor shutter.

7. The system of claim 6, wherein the processing system further comprises:
controlling the sensor shutter.

8. The system of claim 7, wherein the processing system further comprises:
controlling the one or more steering mirrors to direct the laser light from the seed laser to the aimpoint within the detonation chamber at a desired time.

9. The system of claim 8, wherein the processing system further comprises:
controlling the target launch mechanism to direct the non-stationary ICF target to arrive at the aimpoint within the detonation chamber at a desired time.

10. The system of claim 9, wherein the processing system further comprises:
controlling the one or more tracking sensors to identify a position and orientation of the non-stationary ICF target within the detonation chamber at a desired time.

11. A method for pointing and tracking of a non-stationary target as it reaches an aimpoint within an Inertial Confinement Fusion (ICF) system, the method comprising:
placing a non-stationary ICF target within a detonation chamber;
emitting a laser light from a seed laser, having a low-pulse energy, toward the detonation chamber;
manipulating the laser light from the seed laser toward the non-stationary ICF target with one or more steering mirrors;
amplifying the laser light emitted by the seed laser from a low pulse energy to a high pulse energy in a laser gain medium, and wherein the laser gain medium is positioned between the one or more steering mirrors and the detonation chamber;
launching the non-stationary ICF target into the detonation chamber to reach an aimpoint with a target launch mechanism;
observing a position and angular orientation of the non-stationary ICF target as the non-stationary ICF target moves closer to and reaches the aimpoint with one or more tracking sensors; and
processing and controlling the one or more steering mirrors, the target launch mechanism, and the one or more tracking sensors with a processing system.

12. The method of claim 11, further comprising:
Illuminating the detonation chamber with a LED light source as the non-stationary ICF target is launched into the detonation chamber from the target launch mechanism.

13. The method of claim 12, further comprising:
placing a laser shutter located between the one or more steering mirrors and the target chamber.

14. The method of claim 13, further comprising:
launching the non-stationary ICF target through the target shutter before entering the detonation chamber at a precise time and positional orientation.

15. The method of claim 14, further comprising:
controlling the target shutter with the processing system.

16. The method of claim 15, further comprising:
sensing the position and orientation information from the non-stationary ICF target located within the target chamber through a sensor shutter with the one or more tracking sensors.

17. The method of claim 16, further comprising:
controlling the sensor shutter with the processing system.

18. The method of claim 17, further comprising:
controlling the one or more steering mirrors to direct the laser light from the seed laser to the aimpoint within the detonation chamber at a desired time with the processing system.

19. The method of claim 18, further comprising:
controlling the target launch mechanism to direct the non-stationary ICF target to arrive at the aimpoint within the detonation chamber at a desired time with the processing system.

20. The method of claim 19, further comprising:
controlling the one or more tracking sensors to identify a position and orientation of the non-stationary ICF target within the detonation chamber at a desired time with the processing system.
